(19) United States
(12) Patent Application Publication
(10) Pub. No.: US 2007/0149035 A1
(43) Pub. Date: Jun. 28, 2007

(54) Electrical connection assembly

(76) Inventors: Hans-Ulrich Muller, Pfedelbach (DE); Wolfgang Langhoff, Leonberg (DE)

Correspondence Address: BLANK ROME LLP, 600 NEW HAMPSHIRE AVENUE, N.W., WASHINGTON, DC, 20037, US

(21) Appl. No.: 11/638,494

(22) Filed: Dec. 14, 2006

(30) Foreign Application Priority Data
Dec. 28, 2005 (DE) 10 2005 062 709.9

(51) Int. Cl. H01R 4/24

(52) U.S. Cl. 439/417

(57) ABSTRACT

The invention relates to an electrical connection assembly and a method for forming the electrical connection assembly. The electrical connection assembly has a printed conductor, a high current conductor, a first contact element, and a second contact element. The conductor element has a first surface and a second surface opposite the first surface and an opening extending from the first surface to the second surface. The high current conductor is received in the opening and extends substantially perpendicular to the first and second surface. The first contact element is coupled to an end of the high current conductor and place adjacent to the first surface. The second contact element is coupled to an opposite end of the high current conductor and placed adjacent to the second surface so that the printed conductor is clamped between the first contact element and the second contact element.

### FIELD OF THE INVENTION

The present invention relates to an electrical connection assembly. More particularly, the present invention relates to an electrical connection between a cylindrical high current contact socket or a high current contact pin and a planar printed conductor element.

### BACKGROUND OF THE INVENTION

At present, mainly press-fit techniques are used to link high current contact sockets or high current contact pins to boards. In press-fit connections, the high current contact socket is inserted into an undersized hole made in the board. Compared to conventional contact sockets and contact pins, contact sockets and pins suitable for high current applications, e.g. current higher than 100 A, have relatively greater diameters. Because of their greater diameters, high current contact sockets and pins often induce stress in the board where they are inserted, thereby deforming the board. That is especially a problem in the automotive domain, where material thickness often fluctuate due to temperature changes. In practice, that often leads to crack formations in the board and possibly detachment of electrical contacts. Moreover, another disadvantage is that contact surface between the contact socket or pin and the board are small. More specifically, the contact surface is where the contact sockets or contact pins are electrically connected to the board, and only a narrow region is provided where the side of the contact socket or pin contacts the edge of the board opening that receives the contact socket or pin.

### SUMMARY OF THE INVENTION

Accordingly, an object of the invention is to provide an improved connection between a high current conductor and a planar printed conductor element. In one embodiment of the invention, an electrical connection assembly is provided. The electrical connection assembly has a printed conductor element with a first surface and a second surface, a high current conductor, a first contact element, and a second contact element. The conductor element has an opening that extends from the first surface to the second surface. The high current conductor is received in the opening and extends substantially perpendicular to the first and second surface. The first contact element is coupled to an end of the high current conductor and placed adjacent to the first surface. The second contact element is coupled to an opposite end of the high current conductor and placed adjacent to the second surface so that the printed conductor is clamped between first and second contact elements.

In accordance with another embodiment of the invention, a method for forming the electrical connection includes the steps of first coupling a first contact element to the high current conductor. The next step is inserting the high current conductor into an opening of the printed conductor element. Then a second contact element is coupled to the high current conductor. Finally, the printed conductor element is clamped between the first and second contact elements thereby forming an electrical coupling.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side elevational view of an electrical connection assembly in section in accordance with an embodiment of the invention;

FIG. 2 is a perspective view of a contact element of the electrical connection assembly illustrated in FIG. 1;

FIG. 3 is a side elevational view of the electrical connection assembly showing a first assembly step;

FIG. 4 is a side elevational view of the electrical connection assembly showing a second assembly step;

FIG. 5 is a side elevational view of the electrical connection assembly showing a final assembly step; and

FIG. 6 is a side elevational view of an electrical connection assembly in accordance with an alternate embodiment of the invention.

### DETAILED DESCRIPTION OF THE INVENTION

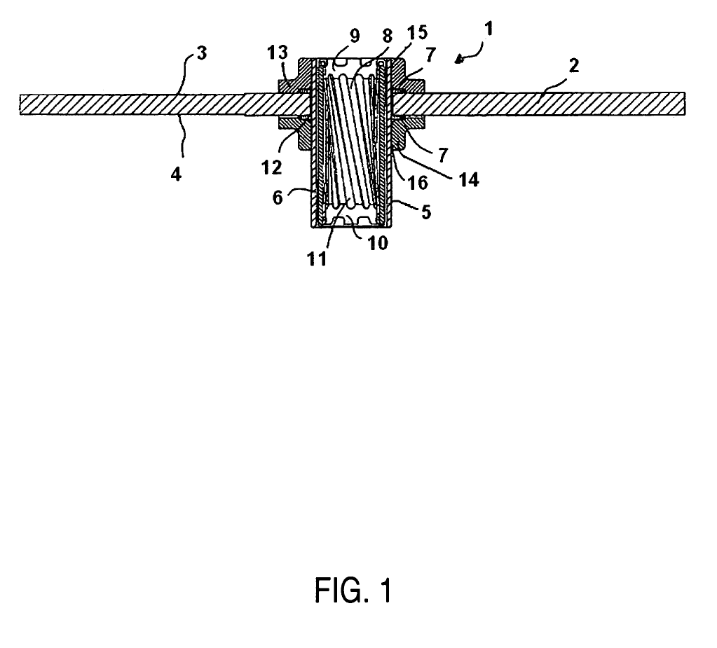

Referring to FIG. 1, an electrical connection assembly in accordance with an embodiment of the invention is shown. The electrical connection assembly includes a high current conductor 5, two substantially identical contact elements 13 and 14, and a printed conductor element 2.

The high current conductor 5 can be a high current contact socket, a high current contact pin, or other similar current conductors. In the preferred embodiment and in FIG. 1, the high current conductor 5 is a conventional high current contact socket. The high current contact socket is preferably suited for use with electrical currents greater than 100 A. The high current conductor 5 has a cylindrical outer sleeve 6 preferably made of metal. Within the outer sleeve 6, there is a tubular part 8, preferably made of sheet metal, for radially contacting with a contact pin (not shown) inserted therein. The tubular part 8 includes a peripherally closed upper ring 9 and a peripherally closed lower ring 10 spaced apart from the upper ring 9. Axially running slots 11 extend between the upper ring 9 and lower ring 10. The axially running slots 11 are curved in a radially inward direction. The upper ring 9 is twisted relative to the lower ring 10 so that the axially running slots 11 curve radially inward.

In another embodiment of the invention, one of the contact elements 13 or 14 is made integral with the high current conductor 5. In particular, the contact element 13 or 14 shaped similar to a nail head is located on one end of the high current conductor 5 so that the high current conductor 5 can be inserted into the opening 12 of the printed conductor element 7 until the contact element 13 or 14 prevents further insertion because the size of the contact element 13 or 14 will not pass through the opening 12 of the printed conductor element 7.

The printed conductor element 2 has a first surface 3 and a second surface 4 opposite to the first surface 3. The printed conductor element 2 can be a board or a pressed screen. The printed conductor element 2 has an opening 12 that extends from the first surface 3 to the second surface 4. Printed conductors 7 may be provided on at least one surface 3 or 4 of the printed conductor element 2.

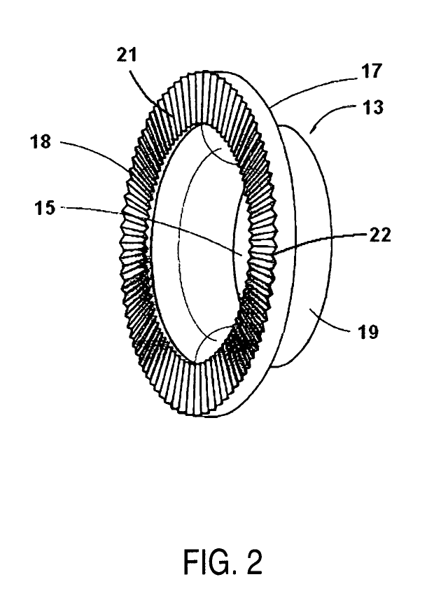

The high current conductor 5 is inserted into opening 12 of the printed conductor element 2 so that a portion of the high current conductor 5 extends substantially perpendicular to the first surface 2 and the second surface 4. Opening 12 may be sized larger than the largest diameter of the high current conductor 5. The high current conductor 5 and printed conductor element 2 are coupled mechanically and electrically by the two contact elements 13 and 14. The contact element 13 couples the high current conductor 5 to the first surface 3 of the printed conductor element 2, and the contact element 14 couples the high current conductor 5 to the opposite second surface 4. Each contact element 13 and 14 has an annular shape providing a contact opening 15 (FIG. 2) and 16, respectively, through which the high current conductor 5 is disposed. Each contact element 13 or 14 is preferably made of an electrically conductive metal. The high current conductor 5 is press fitted into contact openings 15 and 16. The contact element 13 also makes contact with the flat printed conductor 7 on the first surface 3. Likewise the contact element 14 makes contact with the flat printed conductor 7 on the second surface 4.

In another embodiment, only one contact element 13 or 14 may be used where the one contact element 13 or 14 makes contact with the printed conductor 7. In an embodiment where the outer sleeve 6 of conductor 5 is made of plastic, an electrically conductive connection between one of the contact elements 13 or 14 and the tubular part 8 of conductor 5 is provided.

The contact elements 13 and 14 clamp the printed conductor element 2 in the axial direction and hold the high current conductor 5 inmmovably. Pressing the contact elements 13 and 14 toward the printed conductor element 2 while fixing the contact elements 13 and 14 in position provides a clamping contact. Thus, it is not possible to rotate the contact elements 13 and 14 together with the high current conductor 5 around its longitudinal axis.

By contact elements 13 and 14 holding the high current conductor 5 in the oversized opening 12, the electrical connection assembly has the advantage of preventing warping of the printed conductor element 2. The printed conductor element 2 is exposed to a clamping force only in the axial direction from the two contact elements 13 and 14, each of which concurrently come into contact with opposing surfaces 3 and 4 of the printed conductor element 2.

When at least one contact element 13 or 14 receives the high current conductor 5, the connecting forces are distributed uniformly between the high current conductor 5 and the printed conductor element 2 because the contact elements 13 and 14 encircle the high current conductor 5. Contact elements 13 and 14 preferably encircle the high current conductor 5 annularly. In particular, the contact element 13 or 14 is rotationally symmetrical with respect to the longitudinal axis of the high current conductor 5.

The contact element 13 or 14 can be coupled to the high current conductor 5 by several different techniques. At least one of the contact elements 13 or 14 can be coupled to the high current conductor 5 by press fit. By press fitting the contact element, additional fastening mechanisms, such as soldering, are avoided. Another simple, secure and effective way of coupling at least one contact element 13 or 14 to the high current conductor 5 is crimping. A crimping tool is applied to the outer radial surface of the contact element 13 or 14 after the high current conductor 5 is disposed within the contact element 13 or 14. Then, the crimping tool compresses the contact element 13 or 14 so that the contact element 13 or 14 permanently clamps to the high current conductor 5. After crimping the contact element 13 or 14, a force acting radially inward is provided. Similar to press fitting, the need for additional fastening mechanisms, such as soldering, is eliminated.

Another advantage is that connecting forces are distributed uniformly between the high current conductor and the printed conductor element, when at least one contact element is coupled to the high current conductor.

Optimum contact between the contact element 13 or 14 and the printed conductor element 2 is achieved when at least one contact element 13 or 14 makes contact with at least one printed conductor 7. Preferably, the printed conductors 7 are disposed on both surfaces 3 and 4 of the printed conductor element 2. In this embodiment the two contact elements 13 and 14 provide the electrical and mechanical contact. The contact surface is larger than conventional connection methods so that the electrical contact resistance is minimized allowing a large amount of current to flow without excessive heating of the contact points. When at least one contact element 13 or 14 establishes an electrically conductive connection between the high current conductor 5 and the printed conductor element 2, the electrically conductive connection is not susceptible to mechanical loads and temperature fluctuations. The printed conductor 7 can be provided in the region where the contact element 13 or 14 comes into contact with the high current conductor 5, such as a printed conductor eye that peripherally surrounds the high current conductor 5.

Referring to FIG. 2, the contact element 13 is shown. Because contact elements 13 and 14 are substantially identical, only contact element 13 is described. The contact element 13 may include an annular contact section 17, a retaining section 19, and a contact opening 15. The contact element 13 is preferably rotationally symmetrical.

The annular contact section 17 extends in the radial direction and has a gripping surface 18 which is provided as a ridged rim 21. A retaining section 19 runs in the axial direction with the contact opening 15 within which the high current conductor 5 is disposed. The gripping surface 18 enlarges the contact surface between the printed conductor 7 and the contact element 13. The gripping surface 18 may also penetrate a possible oxide layer on the printed conductor 7 which can be provided in the contact area as a printed conductor eye.

Preferably, the contact side 17 of the contact element 13 facing the surface of the printed conductor element 2 has the gripping surface 18 for increasing the contact surface and/or for penetrating an oxide layer. The gripping surface 18 may penetrate any oxide layer located on the top of the printed conductor 7, which in turn minimizes contact resistance. The gripping surface 18 on the contact side 17 can be a ridged rim provided on its periphery where the ridge tips 22 thereof are placed adjacent to the surface of the printed conductor element 2. The tips would then penetrate any oxide layer on the printed conductor 7.

An extremely resilient connection between the high current conductor 5 and the printed conductor element 2 is obtained when at least one contact element 13 or 14 is made elastic in the axial direction. A permanent clamping force between the contact element 13 or 14 and the high current conductor 5 is provided by an induced spring force.

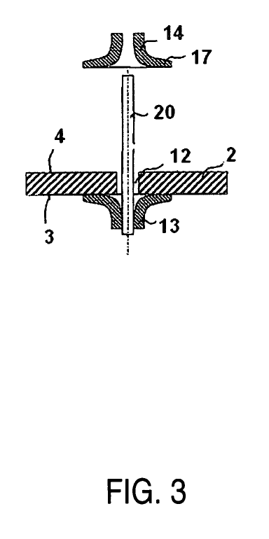

FIGS. 3 to 5 schematically show steps in a connecting method as claimed in the invention. The method has the advantage of avoiding surface warping of the printed conductor element 2. According to the method, a high current conductor, shown as a high current contact pin 20 in FIGS. 3 to 5, with first contact element 13 attached to it or formed integrally is inserted into the opening 12 of the printed conductor element 2 until the contact element 13 adjoins the first surface 3 of the printed conductor element 2. In FIG. 3, the first contact element 13 receives the high current contact pin 20 and applies radial clamping forces to the high current contact pin 20. In one embodiment, the high current contact pin 20 is securely connected to a first contact element 13 by crimping. Then, the high current contact pin 20 is inserted into opening 12 of the printed conductor element 2. Opening 12 may be sized larger than the largest diameter of the high current contact pin 20. The high current contact pin 20 is inserted into the opening 12 until the first contact element 13 prevents further insertion because the size of the first contact element 13 will not pass through the opening 12, and the contact side 17 of the first contact element 13 comes into contact with the first surface 3.

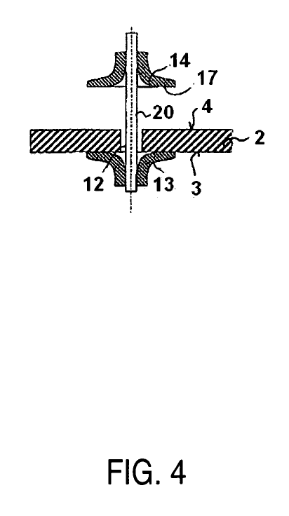

Then, a second contact element 14 receives the high current conductor 5 and is fixed on the second surface 4 of the printed conductor element 2 opposite the first contact element 13. FIG. 4 shows the second contact element 14 being slipped onto the high current contact pin 20 and pushed in the direction of the printed conductor element 2.

The second contact element 14 must come into contact with the printed conductor element 2 so that the printed conductor element 2 is clamped between the two contact elements 13 and 14. The second contact element 14 is pressed against the printed conductor element 2 with an axial pressing force. Simultaneously, it is exposed to a radial force. The radial force compresses the second contact element 14 so that it is crimped thereby clamping it to the high current contact pin 20. When the second contact element 14 is coupled to the high current contact pin 20, a clamping connection is formed where the high current contact pin 20 is coupled to the printed conductor element 2.

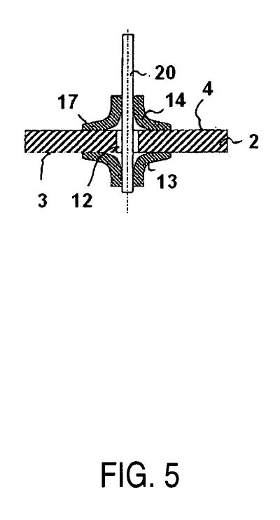

In FIG. 5 the second contact element 14 has made contact with the second surface 4. Since the first and second contact elements 13 and 14 provide a fixed clamping connection between the high current contact pin 20 and the printed conductor element 2, additional connecting mechanisms are not necessary.

The electrical coupling is provided by at least one of the contact elements 13 or 14. If one of the contact elements 13 or 14 is made of an electrically conductive metal, then the contact element 13 or 14 forms an electrical coupling by providing an electrical pathway between the high current conductor and printed conductor element 2, preferably through the printed conductor 7. One of the contact elements 13 or 14 may also be made elastic to provide a more resilient coupling. Also, one of the contact elements 13 or 14 may be provided with the gripping surface 18 to increase the contact area and/or to penetrate a possible oxide layer on the printed conductor 7.

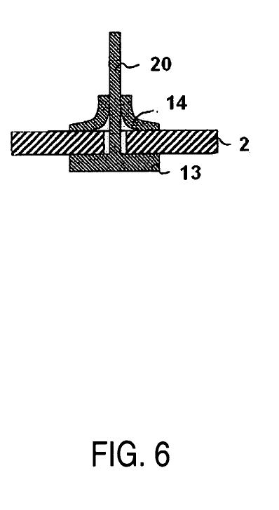

FIG. 6 shows an embodiment where one of the contact elements 13 or 14 is an integral part of the high current contact pin 20. Thus, in the method, the step of attaching the contact element 13 or 14 to the high current contact pin 20 can be omitted.

While particular embodiments have been chosen to illustrate the invention, it will be understood by those skilled in the art that various changes and modifications can be made therein without departing from the scope of the invention as defined in the appended claims.

What is claimed is:

1. An electrical connection assembly, comprising of:
a printed conductor element with a first surface and a second surface opposite said first surface, said planar printed conductor element including an opening extending from said first surface to said second surface;
a high current conductor received in said opening and extending substantially perpendicular to said first surface and said second surface;
a first contact element coupled to an end of said high current conductor and disposed adjacent to said first surface; and
a second contact element coupled to an opposite end of said high current conductor and disposed adjacent to said second surface, said printed conductor being clamped between said first contact element and said second contact element.

2. The electrical connection assembly according to claim 1, wherein one of said first contact element and said second contact element is integral with said high current conductor.

3. The electrical connection assembly according to claim 1, wherein at least one of said first and second contact elements receives the high current conductor.

4. The electrical connection assembly according to claim 1, wherein at least one of said first and second contact elements is pressfit to the high current conductor.

5. The electrical connection assembly according to claim 1, wherein at least one of said first and second contact elements is crimped the high current conductor.

6. The electrical connection assembly according to claim 1, wherein at least one of said first and second contact elements provides an electrically conductive coupling between said high current conductor and said printed conductor element.

7. The electrical connection assembly according to claim 1, wherein at least one of said first and second contact elements elastically deforms in the axial direction.

8. The electrical connection assembly according to claim 1, wherein at least one of said first and second contact elements has a contact side, wherein said contact side is disposed facing said first surface or said second surface and said contact side includes a gripping surface thereby increasing the contact area of said contact side.

9. The electrical connection assembly according to claim 8, wherein said gripping surface of said contact side is a ridged rim.

10. The electrical connection assembly according to claim 1, further comprising at least one printed conductor provided on at least one of said first and second surfaces of said printed conductor element, wherein at least one said printed conductor contacting one said first and second contact elements.

11. The electrical connection assembly according to claim 1, further comprising a printed conductor provided on one said first and second surfaces of said printed conductor element, wherein at least one said first and second contact elements is disposed adjacent to said printed conductor.

12. The electrical connection assembly according to claim 11, wherein said printed conductor is made in a contact region as a printed conductor eye.

13. The electrical connection assembly according to claim 1, wherein said printed conductor element is a board or a pressed screen.

14. The electrical connection assembly according to claim 1, wherein said first and second contact elements are substantially identical.

15. A method for coupling a cylindrical high current conductor to a planar printed conductor element, the method comprising the steps of:
coupling a first contact element to the high current conductor;
inserting the high current conductor into an opening of the printed conductor element;
coupling a second contact element to the high current conductor; and
clamping the printed conductor element between the first and second contact elements thereby forming an electrical coupling.

16. The method according to claim 15, further comprising the step of pressing either the first or second contact element toward the printed conductor element to provide clamping contact with the printed conductor element.

17. The method according to claim 16, further comprising the step of fixing the contact element in position by radial crimping the contact element to the high current conductor, thereby forming the coupling between the second contact element and the high current conductor.

18. The method according to claim 15, wherein either contact element is made integral with the high current conductor.
